(19) United States
(12) Patent Application Publication
(10) Pub. No.: US 2018/0334952 A1
(43) Pub. Date: Nov. 22, 2018

(54) INTERCOOLER SYSTEM

(71) Applicant: K&N Engineering, Inc., Riverside, CA (US)

(72) Inventors: John Concialdi, Riverside, CA (US); Steve Williams, Beaumont, CA (US)

(73) Assignee: K&N Engineering, Inc., Riverside, CA (US)

(21) Appl. No.: 16/036,771

(22) Filed: Jul. 16, 2018

Related U.S. Application Data
(63) Continuation-in-part of application No. 13/473,765, filed on May 17, 2012.
(60) Provisional application No. 61/487,645, filed on May 18, 2011.

(51) Int. Cl. F02B 29/04; F28D 9/00; F28F 3/02

(52) U.S. Cl. CPC F02B 29/0456; F28D 9/0062; F02M 26/31; F28F 3/025; F28D 9/0025

(57) ABSTRACT

An apparatus is provided for an intercooler to maximize air flow to a turbocharger. The intercooler comprises an intercooler core comprising an alternating arrangement of air flow passageways and charge flow passageways. The air flow passageways receive an ambient air flow and the charge flow passageways receive a charge flow, such that heat is transferred from the charge flow to the ambient air flow and removed from the intercooler. A first end tank sealed to a hot side of the intercooler core conducts the charge flow received at a hot fluid inlet to the intercooler core. A second end tank sealed to a cool side of the intercooler core conducts the charge flow from the intercooler core to a cool fluid outlet. A multiplicity of partitions disposed on the hot and cool sides of the intercooler core are configured to promote a laminar flow through the charge flow passageways.

### PRIORITY

This application is a continuation-in-part of, and claims the benefit of, U.S. patent application Ser. No. 13/473,765, filed May 17, 2012, which claims the benefit of U.S. Provisional Application No. 61/487,645 filed May 18, 2011, the entirety of each of the aforementioned applications is incorporated by reference in its entirety into this application.

### FIELD

The field of the present disclosure generally relates to performance parts for motor vehicles. More particularly, the field of the present disclosure relates to an apparatus and method for maximizing airflow through an intercooling device so as to increase performance and longevity of a motor vehicle.

### BACKGROUND

For decades, motor vehicles have been available in many sizes, shapes, and various configurations. Regardless of configuration, however, automotive enthusiasts have derived significant pleasure from modifying various elements of their vehicles with aftermarket parts so as to personalize their vehicles, increase performance, achieve greater horsepower, increase longevity, and the like.

Common aftermarket modifications include replacements and/or enhancements of original equipment manufacturer (OEM) components. For example, one common modification is to replace an OEM exhaust with an aftermarket exhaust having larger diameter piping and free-flow elements so as to increase engine noise and performance. Many individuals also focus on other elements of their vehicle, for example by upgrading components of their vehicle's suspension, as well as interior elements, such as aftermarket stereo systems and the like.

Generally, when aftermarket modifications are made to a motor vehicle that were not anticipated by the manufacturer, other supporting modifications must be made to sustain drivability and longevity of the motor vehicle. This is especially true when significant modifications are made to increase power out from the engine. For example, the most efficient way to increase horsepower is to utilize forced induction, such as via turbocharging or supercharging the engine.

Turbocharging a vehicle increases air pressure entering the engine. A turbocharging system generally comprises a turbine section that is “powered” by the engine's exhaust gases. On the other hand, superchargers are air compressors that force relatively more air into the engine. A problem with forced induction systems is that they introduce unwanted heat into the engine and bay of the vehicle, which serves to decrease engine performance. In an effort to minimize the heat produced by forced induction systems, certain manufacturers have developed intercoolers, which allow a relatively greater mass of air to be admitted into an engine. Thus, an intercooler plays a key role in controlling the internal temperature of a turbocharged engine.

A turbo (as with any form of supercharging system) increases the engine's power, as well as leading to higher combustion pressures and exhaust temperatures. Exhaust gas passing through the turbine section typically has a temperature of around 450° C. (840° F.), but may also reach a temperature as high as 1000° C. (1830° F.) under extreme performance conditions. This heat passes through the turbocharger unit and heats the intake air being compressed in the turbocharger. If left uncooled, the hot intake air enters the engine, thereby increasing the internal temperature of the engine. High temperatures increase the possibility of pre-ignition or detonation in an engine. Detonation causes damaging pressure spikes in the combustion cylinders, which can quickly damage the engine. Pre-ignition and detonation are especially prevalent in modified or tuned engines running at very high power outputs. An efficient intercooler removes heat from the intake air in the forced induction system, preventing cyclic heat build-up via the turbocharger, and thus allows higher power outputs to be achieved without damage to the engine.

Intercoolers may vary dramatically in size, shape and design, depending on the performance and space requirements of the entire forced induction system. Common spatial designs are front mounted intercoolers (FMIC), top mounted intercoolers (TMIC) and hybrid mount intercoolers (HMIC). Each type can be cooled with an air-to-air system, air-to-liquid system, or a combination of both. A drawback to conventional intercoolers is limited air flow and limited air-to-liquid flow generally reduce the efficiency of the intercoolers. Consequently, conventional intercoolers generally are too large for many vehicles, or require significant, irreversible modification to the vehicle receiving the intercooler.

What is needed, therefore, is an improved intercooler and a method for maximizing air flow therethrough, so as to improve vehicle engine performance.

### SUMMARY

An apparatus is provided for an intercooler configured to maximize air flow to a turbocharger so as to increase performance and longevity of a motor vehicle. The intercooler comprises an intercooler core which includes a multiplicity of air flow passageways and a multiplicity of charge flow passageways that share an interspersed, alternating arrangement such that an ambient air flow through the multiplicity of air flow passageways and a charge flow through the multiplicity of charge flow passageways are separated. A first contoured end tank is attached to a hot side of the intercooler core. The first contoured end tank comprises a hot fluid inlet configured to receive the charge flow and having an annular perimeter shape that transitions to a perimeter shape of the intercooler core. A second contoured end tank is attached to a cool side of the intercooler core and configured to receive the charge flow from the multiplicity of charge flow passageways. The second contoured end tank has a perimeter shape of the intercooler core that transitions to an annular perimeter shape of a cool fluid outlet configured to discharge the charge flow from the second contoured end tank. A multiplicity of hot side partitions is disposed on the hot side of the intercooler core between adjacent charge flow passageways and configured with a specific shape suitable for directing the charge flow from the first contoured end tank into the charge flow passageways. A multiplicity of cool side partitions is disposed on the cool side of the intercooler core between adjacent charge flow passageways and configured with a specific shape suitable for directing the charge from the multiplicity of charge flow passageways into the second contoured end tank.

In an exemplary embodiment, an intercooler configured to maximize air flow to a turbocharger so as to increase performance and longevity of a motor vehicle comprises an intercooler core comprising a multiplicity of air flow passageways and a multiplicity of charge flow passageways that share an interspersed, alternating arrangement such that an ambient air flow through the multiplicity of air flow passageways and a charge flow through the multiplicity of charge flow passageways are separated; a first contoured end tank attached to a hot side of the intercooler core, the first contoured end tank comprising a hot fluid inlet configured to receive the charge flow and having an annular perimeter shape that transitions to a perimeter shape of the intercooler core; a second contoured end tank attached to a cool side of the intercooler core and configured to receive the charge flow from the multiplicity of charge flow passageways, the second contoured end tank having a perimeter shape of the intercooler core that transitions to an annular perimeter shape of a cool fluid outlet configured to discharge the charge flow from the second contoured end tank; a multiplicity of hot side partitions disposed on the hot side of the intercooler core between adjacent of the multiplicity of charge flow passageways and configured with a specific shape suitable for directing the charge flow from the first contoured end tank into the multiplicity of charge flow passageways; and a multiplicity of cool side partitions disposed on the cool side of the intercooler core between adjacent of the multiplicity of charge flow passageways and configured with a specific shape suitable for directing the charge from the multiplicity of charge flow passageways into the second contoured end tank.

In another exemplary embodiment, the hot fluid inlet and the cool fluid outlet are configured to mate with intercooler piping, such that intercooler may be installed into a turbocharger system. In another exemplary embodiment, the first contoured end tank and the second contoured end tank comprise smoother internal surfaces and features configured to minimize air turbulence and maximize air flow through the intercooler. In another exemplary embodiment, the first contoured end tank and the second contoured end tank each are formed of a single piece of material so as to promote smooth air flow within the intercooler.

In another exemplary embodiment, a fin configuration is disposed within each of the multiplicity of air flow passageways and each of the multiplicity of charge flow passageways, wherein the fin configurations within the multiplicity of air flow passageways extending from a front of the intercooler core to a rear of the intercooler core, and wherein the fin configurations within the multiplicity of charge flow passageways extend from a hot side to a cool side of the intercooler core. In another exemplary embodiment, the fin configurations disposed within the multiplicity of air flow passageways each comprises a sinusoidal cross-sectional shape. In another exemplary embodiment, the fin configurations disposed within the multiplicity of charge flow passageways each comprises a sinusoidal cross-sectional shape. In another exemplary embodiment, the fin configurations disposed within the multiplicity of air flow passageways each comprises a first cross-sectional shape and the fin configurations disposed within the multiplicity of charge flow passageways each comprises a second cross-sectional shape which is different than the first cross-sectional shape, the first and second cross-sectional shapes depending upon an intended application of the intercooler core and desired degree of heat transfer between the charge flow and the ambient air flow. In another exemplary embodiment, the fin configurations disposed within the multiplicity of air flow passageways each comprises a first density and the fin configurations disposed within the multiplicity of charge flow passageways each comprises a second density, the first and second densities depending upon an intended degree of heat transfer between the charge flow and the ambient air flow, and further depending upon at least a pressure drop of the charge flow traversing the intercooler core.

In another exemplary embodiment, a multiplicity of separating bars are disposed on the front and rear sides of the intercooler core between adjacent of the multiplicity of air flow passageways and configured to prevent fluid communication between the multiplicity of air flow passageways and the multiplicity of charge flow passageways. In another exemplary embodiment, the specific shape of the multiplicity of hot side partitions is configured to provide leading edges which promote a smooth, substantially laminar flow into the charge flow passageways. In another exemplary embodiment, the specific shape of the multiplicity of hot side partitions is an elongated hemispherical cross-sectional shape. In another exemplary embodiment, the multiplicity of hot side partitions are sealed to the intercooler core so as to prevent the charge flow from entering the air flow passageways.

In another exemplary embodiment, the specific shape of the multiplicity of cool side partitions is configured to minimize turbulence of the charge flow exiting the charge flow passageways. In another exemplary embodiment, the specific shape of the multiplicity of cool side partitions is a trailing edge cross-sectional shape. In another exemplary embodiment, the multiplicity of cool side partitions are sealed to the intercooler core so as to prevent the charge flow from entering the air flow passageways.

In an exemplary embodiment, an intercooler configured to maximize air flow to a turbocharger comprises an intercooler core comprising an alternating arrangement of air flow passageways and charge flow passageways, the air flow passageways being configured to receive an ambient air flow, and the charge flow passageways being configured to receive a charge flow, such that heat within the charge flow is transferred to the ambient air flow and removed from the intercooler core; a first end tank sealed to a hot side of the intercooler core and configured to conduct the charge flow received at a hot fluid inlet to the intercooler core; a second end tank sealed to a cool side of the intercooler core and configured to conduct the charge flow from the intercooler core to a cool fluid outlet; a multiplicity of hot side partitions disposed on the hot side of the intercooler core between adjacent of the charge flow passageways; and a multiplicity of cool side partitions disposed on the cool side of the intercooler core between adjacent of the charge flow passageways.

In another exemplary embodiment, each of the multiplicity of the hot side partitions is configured with a specific shape suitable for directing the charge flow from the first end tank into the charge flow passageways, and wherein each of the multiplicity of the cool side partitions is configured with a specific shape suitable for directing the charge from the charge flow passageways into the second end tank. In another exemplary embodiment, the specific shape selected for the hot side partitions and the specific shape selected for the cool side partitions are configured to promote a substantially laminar flow such that turbulence of the charge flow is minimized within the intercooler. In another exemplary embodiment, the first end tank comprises a perimeter shape suitable for sealing to the hot side of the intercooler core and transitions to an annular perimeter shape of the hot fluid inlet, and where the second end tank comprises a perimeter shape suitable for sealing to the cool side of the intercooler core and transitions to an annular perimeter shape of the cool fluid outlet.

### BRIEF DESCRIPTION OF THE DRAWINGS

The drawings refer to embodiments of the present disclosure in which:

FIG. 1 is a perspective view illustrating an exemplary embodiment of an intercooler comprising end tanks and an intercooler core, according to the present disclosure;

FIG. 2 is an isometric view illustrating the intercooler core of FIG. 1 in accordance with the present disclosure;

FIG. 3 is a cross-sectional view taken along a midline of the intercooler of FIG. 1 in accordance with the present disclosure;

FIG. 4 is a close-up cross-sectional view of an exemplary embodiment of a hot side of an intercooler core, according to the present disclosure; and

FIG. 5 is a close-up cross-sectional view of an exemplary embodiment of a cool side of an intercooler core in accordance with the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first end tank,” may be made. However, the specific numeric reference should not be interpreted as a literal sequential order but rather interpreted that the “first end tank” is different than a “second end tank.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus for an intercooler to maximize air flow to a turbocharger. The intercooler comprises an intercooler core comprising an alternating arrangement of air flow passageways and charge flow passageways. The air flow passageways receive an ambient air flow and the charge flow passageways receive a charge flow, such that heat is transferred from the charge flow to the ambient air flow and removed from the intercooler. A first end tank sealed to a hot side of the intercooler core conducts the charge flow received at a hot fluid inlet to the intercooler core. A second end tank sealed to a cool side of the intercooler core conducts the charge flow from the intercooler core to a cool fluid outlet. A multiplicity of partitions disposed on the hot and cool sides of the intercooler core are configured to promote a laminar flow through the charge flow passageways. The multiplicity of partitions have specific shapes suitable for directing the charge flow through the intercooler core with minimal turbulence. The first and second end tanks each comprises a perimeter shape suitable for sealing with the intercooler core. The perimeter shape of the first end tank smoothly transitions from the shape of the intercooler core to an annular perimeter shape of the hot fluid inlet. Similarly, the perimeter shape of the second end tank smoothly transitions from the shape of the intercooler core to an annular perimeter shape of the cool fluid outlet.

It should be understood that the intercooler described herein may be disposed in a number of different locations, depending on the configuration of the vehicle. For example, in applications wherein the engine is mounted at a front of the vehicle, the intercooler may be disposed within a cavity of a front bumper of the vehicle so as to receive cool ambient air therethrough. For mid-engine or rear-engine applications, the intercooler may be placed in a top-mount configuration and combined with appropriate ducting to receive cool air. Furthermore, because front-mount intercooler (FMIC) systems require an open bumper design for optimal performance, the entire system is vulnerable to road debris. Consequently, it should be appreciated that other mount locations may be utilized due to this reliability concern. Furthermore, FMICs may be located in front of or behind a radiator, depending on heat dissipation requirements of the engine.

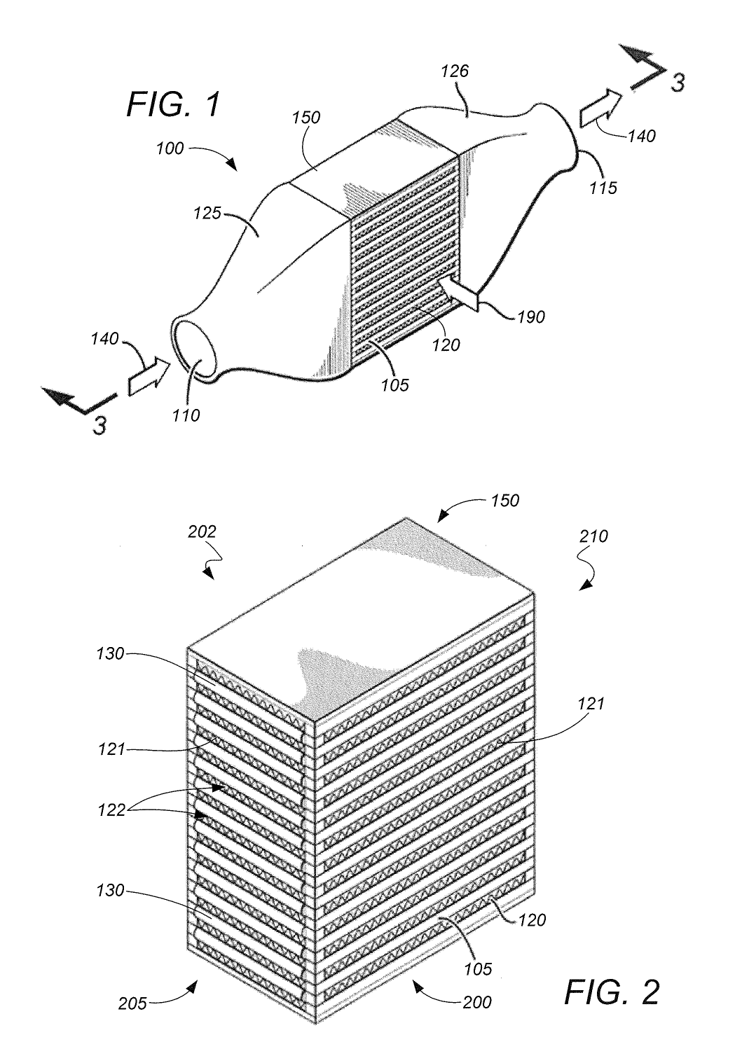

FIG. 1 is a perspective view illustrating an exemplary embodiment of an intercooler 100 in accordance with the present disclosure. The intercooler 100 comprises a first and second contoured end tanks 125 and 126, respectively. The first contoured end tank 125 further comprises a hot fluid inlet 110 that is configured so as to allow a charge flow 140 to pass therethrough. As the charge flow 140 passes through the intercooler 100, an ambient air flow 190 passes through an intercooler core 150, effectively reducing the temperature of the charge flow 140. Finally, the cooled charge flow 140 is directed through the second contoured end tank 126 until it exits through a cool fluid outlet 115. As will be appreciated, the intercooler 100 operates similarly to a heat exchanger whereby heat is transferred from the charge flow 140 to the ambient air flow 190, which then removes the heat from the intercooler.

The first and second contoured end tanks 125, 126 are configured with a specific shape so as to increase volumetric efficiency with respect to the air passing therethrough. Preferably, the contoured end tanks 125, 126 comprise smooth internal surfaces and features configured to minimize air turbulence and maximize airflow. As shown in FIG. 1, the end tanks 125, 126 have a generally smooth shape, although it is contemplated that any number of shapes other than those illustrated in FIG. 1 may be incorporated into the intercooler 100. In the exemplary embodiment of FIG. 1, the shape of the end tank 125 transitions from a generally annular perimeter shape of the hot fluid inlet 110 to the perimeter shape of the intercooler core 150. Similarly, the shape of the end tank 126 transitions from a generally annular perimeter shape of the cool fluid outlet 115 to the perimeter shape of the intercooler core 150. The intercooler core 150 is configured so as to function as a heat sink which absorbs relatively more heat from the charge flow 140 than conventional intercoolers. Thus, the intercooler core 150 described herein is especially useful in stop-and-go traffic as it is configured to keep the charge flow 140 relatively cool and dissipate heat while the vehicle is in motion.

The first and second contoured end tanks 125, 126 may be comprised of any of various suitable metals, such as, without limitation, cast aluminum, titanium, steel, iron, and the like. The end tanks 125, 126 may be coupled to the intercooler core 150 using any number of methods, including welding, any of various fasteners, as well as any of various mechanisms, such as hinges, latches, straps and the like. As will be appreciated, the hot fluid inlet 110 and the cool fluid outlet 115 of the end tanks 125, 126 are configured to mate with intercooler piping (not shown), such that the intercooler 100 may be installed into various turbocharger systems. Any number of techniques may be used to mate the hot fluid inlet 110 and the outlet 115 with intercooler piping, such as for example using any of various clamps, couplers, or welded components, alone or in combination, without limitation. In the embodiment illustrated in FIG. 1, the hot fluid inlet 110 and the outlet 115 are respectively configured in an annular arrangement at the outermost center edge of the contoured end tanks 125, 126. Further, the end tanks 125, 126 preferably are molded and/or formed from a single material so as to promote smooth air flow therethrough. It is contemplated, however, that multiple sections of material may be welded and/or shaped to achieve the smooth, contoured shape as discussed herein.

The dimensions of the intercooler 100 may vary in height, width, and depth depending on the application. It should be understood, however, that greater surface area translates into an increased cooling of the charge flow 140. However, a larger surface area is favored over a thicker intercooler core 150. Observations indicate that a larger surface area provides a greater cooling face for the ambient air flow 190, and thus is more effective than a thicker core. Consequently, achieving greater maximum height is more beneficial than increasing the thickness of the intercooler 100. Further, as compared to conventional, sharp-angled end tanks, the contoured end tanks 125, 126 are configured so as to supply the entire intercooler core 150 with smooth, less turbulent air flow. It is to be understood that the contoured end tanks 125, 126, therefore, may be reduced in size and volume, as compared to conventional end tanks, whereby the forced induction response, efficiency, and pressure drop are positively affected.

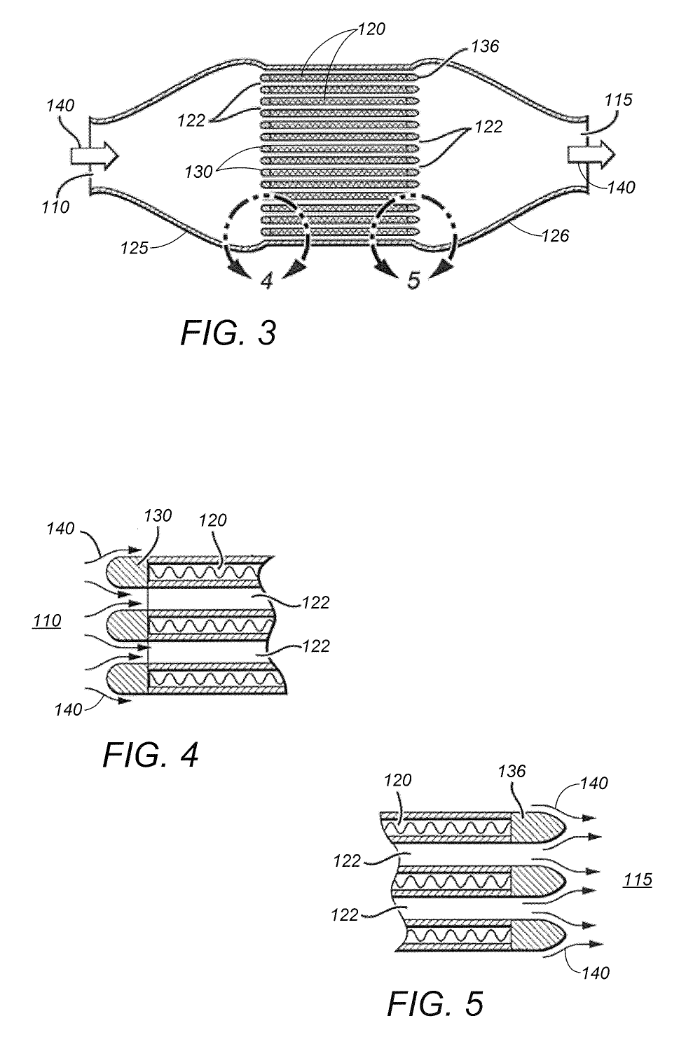

FIG. 2 is an isometric view of the intercooler core 150 in absence of the first and second contoured end tanks 125, 126. The intercooler core 150 comprises a series of air flow passageways 120, each of which extending from a front 200 to a rear 202 of the core 150. Similarly, the core 150 comprises a series of charge flow passageways 122 extending from a hot side 205 to a cool side 210 of the core 150. As shown in FIGS. 2 and 3, the air flow passageways 120 and the charge flow passageways 122 share an interspersed, alternating arrangement such that the ambient air flow 190 through the passageways 120 and the charge flow 140 through the passageways 122 are separated from one another within the intercooler core 150. As best shown in FIG. 2, a separating bar 105 borders each of the charge flow passageways 122 along the front 200 and rear 202 of the core. The separating bars 105 prevent the air flow 190 from entering the passageways 122. Likewise, as best shown in FIG. 3, each of the air flow passageways 120 is bordered by a hot side partition 130 along the hot side 205 of the core 150, and bordered by a cool side partition 136 along the cool side 210. The partitions 130, 136 prevent the charge flow 140 from entering the passageways 120. The separating bars 105 and the partitions 130, 136 preferably are sealed to the intercooler core 150 so as to prevent mixing of the ambient air flow 190 and the charge flow 140. As will be appreciated, however, heat within the charge flow 140 through the passageways 122 will transfer to the cooler ambient air flow 190 through the passageways 120. Thus, the intercooler core 150 operates effectively as a heat exchanger that reduces the temperature of the charge flow 140 passing from the hot side 205 to the cool side 210 of the core 150.

A fin configuration 121 is disposed within each of the passageways 120, 122. The fin configurations 121 within the air flow passageways 120 extend from the front 200 to the rear 202 of the intercooler core 150. Similarly, the fin configurations 121 disposed within the charge flow passageways 122 extend from the hot side 105 to the cool side 110 of the core 150. As will be recognized, the fin configurations 121 serve to more efficiently transfer heat between the flows 190, 140 and respective surfaces of the passageways 120, 122. In the exemplary embodiment illustrated in FIGS. 1-2, the fin configuration 121 comprise a generally sinusoidal cross-sectional shape. It is contemplated, however, that the fin configurations 121 may be practiced with any cross-sectional shape suitable for heat transfer. Further, in some embodiments, differently shaped cross-sectional shapes of the fins may be implemented in the passageways 120, 122. For example, in one embodiment the fin configurations 121 in the air flow passageways 120 may have a sinusoidal cross-sectional shape, whereas the fin configurations in the charge flow passageways 122 may possess a generally saw tooth cross-sectional shape. Thus, any of various cross-sectional shapes may be applied to the fin configurations disposed within the passageways 120, 122, depending upon the intended application of the intercooler core 150, as well as a desired degree of heat transfer between the flows 190, 140, without limitation, and without deviating beyond the spirit and scope of the present disclosure.

Moreover, it will be appreciated that the relative density of the fin configurations 121 may be increased or decreased depending on the desired application. As will be recognized, however, the density of the fin configurations 121 has a direct impact on a decrease in pressure exhibited by the flows 190, 140 traversing the intercooler core 150. Such a decrease in pressure may have an adverse effect on the efficiency of the turbocharger. For example, while a relatively dense fin configuration 121 may offer superb heat transfer, the density of the fins may also give rise to a severe drop in pressure across the intercooler core 150. In the case of the charge flow 140, the severe pressure drop reduces the effectiveness of the turbocharger. Thus, those skilled in the art will appreciate that the density of the fin configurations 121 may be varied, and weighed as a function of at least pressure within in the intercooler core 150, depending on the intended application, and without limitation.

As discussed above, the separating bars 105 prevent the air flow 190 from entering the passageways 122, and the partitions 130, 136 prevent the charge flow 140 from entering the passageways 120. Thus, the separating bars 105 and the partitions 130, 136 preferably are sealed to the intercooler core 150 so as to prevent mixing of the ambient air flow 190 and the charge flow 140. Although in the embodiment illustrated in FIGS. 1-3, each of the separating bars 105 comprises a generally flat member sealed to the intercooler core 150, any of the separating bars 105 and the partitions 130, 136 may be practiced with specific shapes so as to advantageously affect air flow through the passageways 120, 122. Accordingly, FIG. 4 is a close-up cross-sectional view of the hot side 205 of the intercooler core 150, showing the hot side partitions 130 having an elongated hemispherical cross-sectional shape. As will be appreciated, the hemispherical shape of the hot side partitions 130 provides a leading edge which operates to smoothly direct the charge flow 140 into the passageways 122. FIG. 5 is a close-up cross-sectional view of the cool side 210 of the core 150, showing the cool side partitions 136 having a trailing edge cross-sectional shape which is configured to minimize turbulence as the charge flow 140 exits the passageways 122.

Those skilled in the art will appreciate that the partitions 130, 136 resemble the leading and trailing edges of a wing, and thus the partitions 130, 136 operate to pass the charge flow 140 through the passageways 122 with an advantageously minimal degree of turbulence. It should be understood, however, that the partitions 130, 136 are not to be limited to the cross-sectional shapes illustrated in FIGS. 4-5, but rather any suitable cross-sectional shape may be incorporated into any of the partitions 130, 136 and the separating bars 105, as deemed advantageous, without limitation, and without deviating beyond the spirit and scope of the present disclosure.

It should be understood that the intercooler 100 may be produced by way of any of a plurality of manufacturing techniques. In some embodiments, the intercooler 100 may be manufactured by way of vacuum furnace brazing, whereby the components comprising the intercooler 100 are arranged together with thin layers of aluminum cladding before being placed into an appropriate furnace. Since the cladding has a melting point which is slight lower in temperature than the components comprising the intercooler 100, the furnace essentially melts the components together. In some embodiments, the intercooler 100 may be manufactured by way of controlled atmospheric brazing (CAB), wherein the various components comprising the intercooler 100 are assembled and then dipped into a cladding solution. Those skilled in the art will recognize that vacuum furnace brazing and controlled atmospheric brazing are advantageous manufacturing techniques that exclude air, and thus preventing a formation of oxides.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. An intercooler configured to maximize air flow to a turbocharger so as to increase performance and longevity of a motor vehicle, comprising:
an intercooler core comprising a multiplicity of air flow passageways and a multiplicity of charge flow passageways that share an interspersed, alternating arrangement such that an ambient air flow through the multiplicity of air flow passageways and a charge flow through the multiplicity of charge flow passageways are separated;
a first contoured end tank attached to a hot side of the intercooler core, the first contoured end tank comprising a hot fluid inlet configured to receive the charge flow and having an annular perimeter shape that transitions to a perimeter shape of the intercooler core;
a second contoured end tank attached to a cool side of the intercooler core and configured to receive the charge flow from the multiplicity of charge flow passageways, the second contoured end tank having a perimeter shape of the intercooler core that transitions to an annular perimeter shape of a cool fluid outlet configured to discharge the charge flow from the second contoured end tank;
a multiplicity of hot side partitions disposed on the hot side of the intercooler core between adjacent of the multiplicity of charge flow passageways and configured with a specific shape suitable for directing the charge flow from the first contoured end tank into the multiplicity of charge flow passageways; and
a multiplicity of cool side partitions disposed on the cool side of the intercooler core between adjacent of the multiplicity of charge flow passageways and configured with a specific shape suitable for directing the charge from the multiplicity of charge flow passageways into the second contoured end tank.

2. The intercooler of claim 1, wherein the hot fluid inlet and the cool fluid outlet are configured to mate with intercooler piping, such that intercooler may be installed into a turbocharger system.

3. The intercooler of claim 1, wherein the first contoured end tank and the second contoured end tank comprise smoother internal surfaces and features configured to minimize air turbulence and maximize air flow through the intercooler.

4. The intercooler of claim 1, wherein the first contoured end tank and the second contoured end tank each are formed of a single piece of material so as to promote smooth air flow within the intercooler.

5. The intercooler of claim 1, wherein a fin configuration is disposed within each of the multiplicity of air flow passageways and each of the multiplicity of charge flow passageways, wherein the fin configurations within the multiplicity of air flow passageways extending from a front of the intercooler core to a rear of the intercooler core, and wherein the fin configurations within the multiplicity of charge flow passageways extend from a hot side to a cool side of the intercooler core.

6. The intercooler of claim 5, wherein the fin configurations disposed within the multiplicity of air flow passageways each comprises a sinusoidal cross-sectional shape.

7. The intercooler of claim 5, wherein the fin configurations disposed within the multiplicity of charge flow passageways each comprises a sinusoidal cross-sectional shape.

8. The intercooler of claim 5, wherein the fin configurations disposed within the multiplicity of air flow passageways each comprises a first cross-sectional shape and the fin configurations disposed within the multiplicity of charge flow passageways each comprises a second cross-sectional shape which is different than the first cross-sectional shape, the first and second cross-sectional shapes depending upon an intended application of the intercooler core and desired degree of heat transfer between the charge flow and the ambient air flow.

9. The intercooler of claim 5, wherein the fin configurations disposed within the multiplicity of air flow passageways each comprises a first density and the fin configurations disposed within the multiplicity of charge flow passageways each comprises a second density, the first and second densities depending upon an intended degree of heat transfer between the charge flow and the ambient air flow, and further depending upon at least a pressure drop of the charge flow traversing the intercooler core.

10. The intercooler of claim 1, wherein a multiplicity of separating bars are disposed on the front and rear sides of the intercooler core between adjacent of the multiplicity of air flow passageways and configured to prevent fluid communication between the multiplicity of air flow passageways and the multiplicity of charge flow passageways.

11. The intercooler of claim 1, wherein the specific shape of the multiplicity of hot side partitions is configured to provide leading edges which promote a smooth, substantially laminar flow into the charge flow passageways.

12. The intercooler of claim 11, wherein the specific shape of the multiplicity of hot side partitions is an elongated hemispherical cross-sectional shape.

13. The intercooler of claim 11, wherein the multiplicity of hot side partitions are sealed to the intercooler core so as to prevent the charge flow from entering the air flow passageways.

14. The intercooler of claim 1, wherein the specific shape of the multiplicity of cool side partitions is configured to minimize turbulence of the charge flow exiting the charge flow passageways.

15. The intercooler of claim 14, wherein the specific shape of the multiplicity of cool side partitions is a trailing edge cross-sectional shape.

16. The intercooler of claim 14, wherein the multiplicity of cool side partitions are sealed to the intercooler core so as to prevent the charge flow from entering the air flow passageways.

17. An intercooler configured to maximize air flow to a turbocharger, comprising:
an intercooler core comprising an alternating arrangement of air flow passageways and charge flow passageways, the air flow passageways being configured to receive an ambient air flow, and the charge flow passageways being configured to receive a charge flow, such that heat within the charge flow is transferred to the ambient air flow and removed from the intercooler core;
a first end tank sealed to a hot side of the intercooler core and configured to conduct the charge flow received at a hot fluid inlet to the intercooler core;
a second end tank sealed to a cool side of the intercooler core and configured to conduct the charge flow from the intercooler core to a cool fluid outlet;
a multiplicity of hot side partitions disposed on the hot side of the intercooler core between adjacent of the charge flow passageways; and
a multiplicity of cool side partitions disposed on the cool side of the intercooler core between adjacent of the charge flow passageways.

18. The intercooler of claim 17, wherein each of the multiplicity of the hot side partitions is configured with a specific shape suitable for directing the charge flow from the first end tank into the charge flow passageways, and wherein each of the multiplicity of the cool side partitions is configured with a specific shape suitable for directing the charge from the charge flow passageways into the second end tank.

19. The intercooler of claim 18, wherein the specific shape selected for the hot side partitions and the specific shape selected for the cool side partitions are configured to promote a substantially laminar flow such that turbulence of the charge flow is minimized within the intercooler.

20. The intercooler of claim 17, wherein the first end tank comprises a perimeter shape suitable for sealing to the hot side of the intercooler core and transitions to an annular perimeter shape of the hot fluid inlet, and where the second end tank comprises a perimeter shape suitable for sealing to the cool side of the intercooler core and transitions to an annular perimeter shape of the cool fluid outlet.
